(19) United States
(12) Patent Application Publication
(10) Pub. No.: US 2013/0124729 A1
(43) Pub. Date: May 16, 2013

(54) COMMUNICATION APPARATUS AND CONTROL METHOD FOR COMMUNICATION APPARATUS

(71) Applicant: CANON KABUSHIKI KAISHA, Tokyo (JP)

(72) Inventor: Nobuhiro Ikeda, Yokohama-shi (JP)

(73) Assignee: CANON KABUSHIKI KAISHA, Tokyo (JP)

(21) Appl. No.: 13/666,595

(22) Filed: Nov. 1, 2012

(30) Foreign Application Priority Data
Nov. 10, 2011 (JP) 2011-246861
Sep. 4, 2012 (JP) 2012-194409

(51) Int. Cl. G06F 15/16

(52) U.S. Cl. 709/225

(57) ABSTRACT

A communication apparatus establishes a communication link with another communication apparatus, and establishes a communication session with another communication apparatus using the established communication link. After a predetermined number of communication sessions have been established, the communication apparatus restricts communication sessions other than the predetermined number of established communication sessions.

### BACKGROUND OF THE INVENTION

1. Field of the Invention

The present invention relates to a communication apparatus and a control method therefor.

2. Description of the Related Art

A direct printing service (DPS) function is installed on some digital cameras and printers. The DPS function enables printing in a state where a digital camera is directly connected to a printer, without having to transport image data captured by the digital camera to a personal computer. Installation of the DPS function allows a user to print out image data in a digital camera by connecting the digital camera directly to a printer. A representative communication standard for such a direct printing service is “PictBridge”. PictBridge-capable devices can directly perform printing by being connected to each other using a USB cable, without having to install special software. Furthermore, PictBridge uses USB as a physical layer and a picture transfer protocol (PTP) as a data communication protocol.

It is conceivable that an IP network may be used as a means of connection between a digital camera and a printer in DPS in place of USB. Although PTP is based on USB connection, with rapid dissemination of home-use wireless products in recent years, PTP has been extended to be compatible with IP. The resultant PTP/IP enables transfer over a wireless LAN. With the use of PTP/IP, devices in a network can manage a plurality of sessions.

Digital cameras and printers with wireless functions use a device discovery service, such as Universal Plug and Play (UPnP), to obtain device information in a network and the like. For example, Japanese Patent Laid-Open No. 2007-142493 (hereinafter, Document 1) describes an image output system including wireless digital still cameras and a printer on which communication software with communication protocols such as PictBridge, UPnP, PTP/IP and TCP/IP is installed. When the image output system of Document 1 detects access by a high-priority image output apparatus while being connected to a low-priority image output apparatus, it changes the destination of connection to the high-priority image output apparatus.

On the other hand, Japanese Patent Laid-Open No. 2004-322420 (hereinafter, Document 2) describes a communication system in which a plurality of imaging apparatuses (digital cameras) are wirelessly connected to an image output apparatus (printer). The communication system of Document 2 notifies the second imaging apparatus of the operational status of the image output apparatus in response to an inquiry from the second imaging apparatus, and therefore can solve the problem that the second and subsequent imaging apparatuses are kept waiting while being wirelessly connected to the image output apparatus.

In addition, for example, a communication terminal apparatus of Japanese Patent Laid-Open No. 2004-266330 (hereinafter, Document 3) includes a lower layer management section that reports lower layer information, such as radio field intensity and network congestion, to an upper layer. In Document 3, a connection control section related to an application directly recognizes lower layer information. The communication terminal apparatus of Document 3 makes possible various kinds of status determination and control changes based on lower layer information at the application level.

Assume the case where cameras and printers with general wireless functions support DPS. In this case, for example, while the number of sessions that can be managed by PictBridge is one, a plurality of wireless communication links can be established in lower layers constituted by PTP/IP communication and UPnP. Therefore, in current internal processing, communication sessions satisfy the ratio 1:n in terms of number of sessions, which causes inconsistency in session management.

Furthermore, when a plurality of digital cameras transmit requests to start a communication session to a printer over wireless links, the printer may respond to the requests to start a communication session from the plurality of digital cameras depending on the timing of internal processing of UPnP and the like. As a result, in the digital cameras, processing for establishing subsequent communication sessions is not activated due to protocol rules. This causes various disadvantages, such as a decrease in the security level of the network due to communication ports being left open. Note that “the timing of internal processing” mentioned above indicates a time lag in event notification to an application, a job execution by an application, etc.

### SUMMARY OF THE INVENTION

According to one aspect of the present invention, there is provided an apparatus that achieves consistency between a communication session managed by communication protocol software and a communication session managed by a wireless link processor that can establish a plurality of links.

A communication apparatus according to one aspect of the present invention includes: a link establishment unit that establishes a communication link with another communication apparatus; a session establishment unit that establishes a communication session with another communication apparatus using a communication link established by the link establishment unit; and a control unit that, after the session establishment unit has established a predetermined number of communication sessions, restricts communication sessions other than the established communication sessions.

Further features of the present invention will become apparent from the following description of exemplary embodiments (with reference to the attached drawings).

### BRIEF DESCRIPTION OF THE DRAWINGS

FIGS. 1A and 1B show examples of configurations of networks according to embodiments.

FIG. 2 is a block diagram showing an example of a configuration of communication apparatuses according to embodiments.

FIG. 3 shows a configuration of protocol layers in the communication apparatuses according to embodiments.

FIG. 4 is a sequence chart of communication processing according to First Embodiment.

FIGS. 5A and 5B are flowcharts for a TCP/IP protocol part of a printer according to First Embodiment.

FIG. 6 is a flowchart for a session-link controller of the printer according to First Embodiment.

FIG. 7 is a sequence chart of communication processing according to Second Embodiment.

FIGS. 8A and 8B are flowcharts for a session-link controller of a printer according to Second Embodiment.

FIG. 9 is a sequence chart of communication processing according to Third Embodiment.

FIGS. 10A and 10B are flowcharts for a TCP/IP protocol part of cameras according to First to Third Embodiments.

FIG. 11 is a flowchart for a session-link controller of a camera according to Third Embodiment.

FIG. 12 shows a configuration of protocol layers in communication apparatuses according to embodiments.

FIG. 13 is a sequence chart of processing according to First Embodiment.

### DESCRIPTION OF THE EMBODIMENTS

The following describes some of the preferred embodiments of the present invention with reference to the accompanying drawings.

### First Embodiment

(System Configuration)

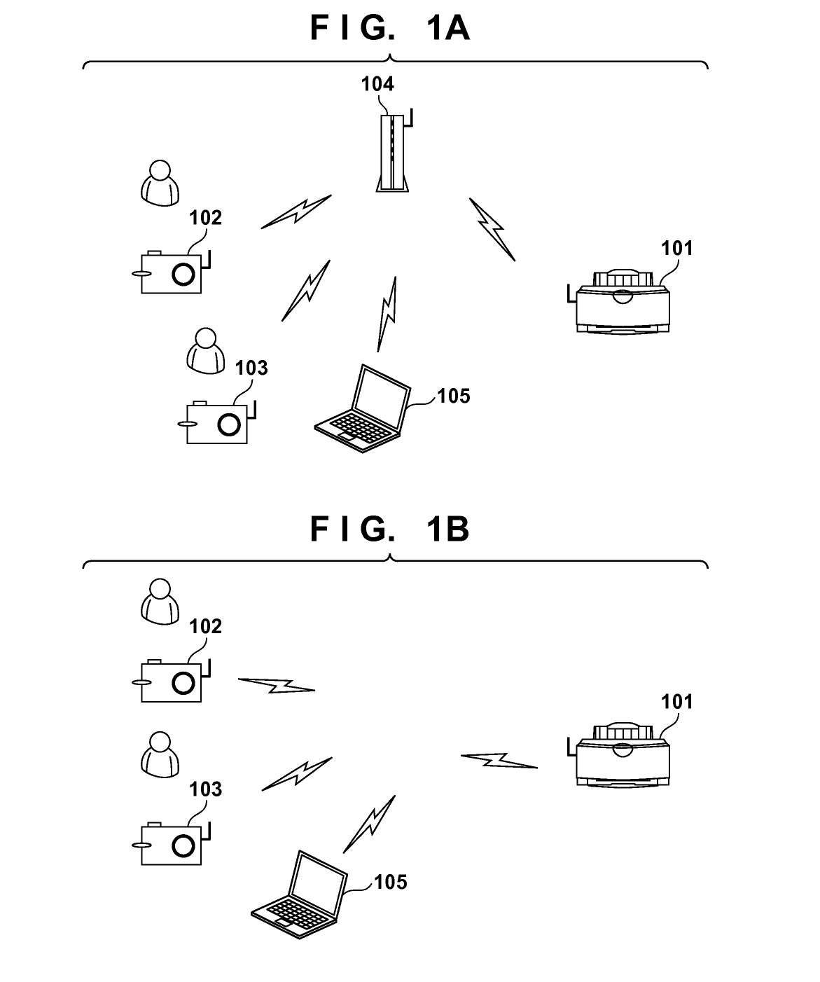

FIG. 1A shows a network configuration of a wireless communication system according to First Embodiment. In FIG. 1A, a printer 101 includes a wireless communication apparatus that can perform communication by building a wireless communication link in accordance with a predetermined communication method. The following description mainly discusses the operations of this wireless communication apparatus. For simplicity, the term “printer” encompasses the functions of the wireless communication apparatus in the following description.

Digital cameras 102 and 103 include wireless communication apparatuses that can perform communication by building a wireless communication link in accordance with a predetermined communication method. The following description mainly discusses the operations of these wireless communication apparatuses. For simplicity, the term “camera(s)” encompasses the functions of the wireless communication apparatuses in the following description. Although digital cameras are discussed as examples in the following description, the present invention is not limited to the digital cameras. For example, the digital cameras may be replaced by mobile telephones and smartphones with imaging functions, or by any apparatus that transfers and receives data via electronic communication regardless of the main use thereof.

An access point 104 defines a communication area. A portable personal computer 105 includes a wireless communication apparatus that can perform communication by building a wireless communication link in accordance with a predetermined communication method. The following description mainly discusses print processing executed by the personal computer to cause the printer 101 to perform printing using wireless communication functions. For simplicity, the term “PC” encompasses such wireless functions and print processing functions in the following description.

The printer 101, the camera 102, the camera 103 and the PC 105 exist in the communication area defined by the access point 104, and perform wireless communication by building a communication link between themselves and the access point 104. In the present embodiment, a first communication link 1 is built between the printer 101 and the camera 102, and a second communication link 2 is built between the printer 101 and the camera 103. Furthermore, a third communication link 3 is built between the printer 101 and the PC 105.

In the present embodiment, the first, second and third communication links use a wireless LAN as a communication method. FIG. 1A illustrates a network configuration that uses an infrastructure network via the wireless LAN. However, the present invention is not limited to such a network configuration. Alternatively, for example, the present invention may use a network configuration that uses an ad-hoc network shown in FIG. 1B. In FIG. 1B, the first, second and third communication links use a wireless LAN as a communication method as in FIG. 1A. FIG. 1B illustrates a network configuration that uses an ad-hoc network in which the access point 104 is not used. Alternatively, the communication method used among the printer 101, the camera 102, the camera 103 and the PC 105 may be a wireless communication method other than the wireless LAN.

(Apparatus Configuration)

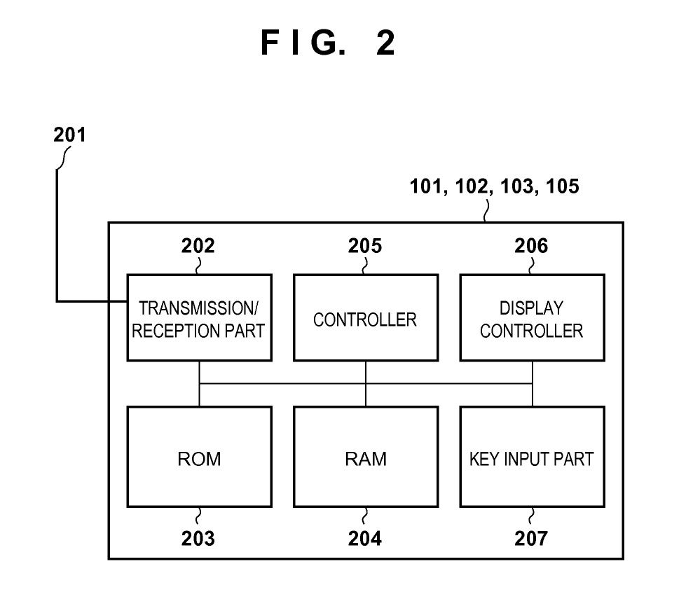

FIG. 2 is a block diagram illustrating common parts of processing blocks constituting the printer 101, the camera 102, the camera 103 and the PC 105 according to the present embodiment. Functional parts unique to each apparatus (printer functions, camera functions and PC functions) are omitted in FIG. 2. In FIG. 2, 201 denotes an antenna, 202 denotes a transmission/reception part that transmits and receives wireless signals via the antenna 201, and 203 denotes a non-volatile memory part (ROM). Also, 204 denotes a volatile memory (RAM) and provides a work memory for a controller 205. Also, 205 denotes a controller and executes various types of processing of the printer 101, the camera 102, the camera 103 and the PC 105 by executing programs stored in the ROM 203. Also, 206 denotes a display controller, and 207 denotes a key input part that, for example, inputs information and performs operations for device control.

(Software (Protocol Layer) Configuration of Apparatuses)

In the present embodiment, the cameras 102 and 103 have a DPS function of building a wireless communication link between themselves and the printer 101 and printing image data using a first image printing protocol, such as PictBridge, in an application layer. In terms of specific software configuration, the printer 101 has a Server function of DPS, and the cameras 102 and 103 have a Client function of DPS. They provide a printing service by exchanging messages in the application layer. The printer 101 also has an Initiator function of PTP, which is a protocol indispensable for PictBridge, and PTP/IP. The cameras 102 and 103 also have a Responder function of PTP and PTP/IP. PTP/IP is a communication protocol for establishing a communication session between the printer 101 and the camera 102, or between the printer 101 and the camera 103.

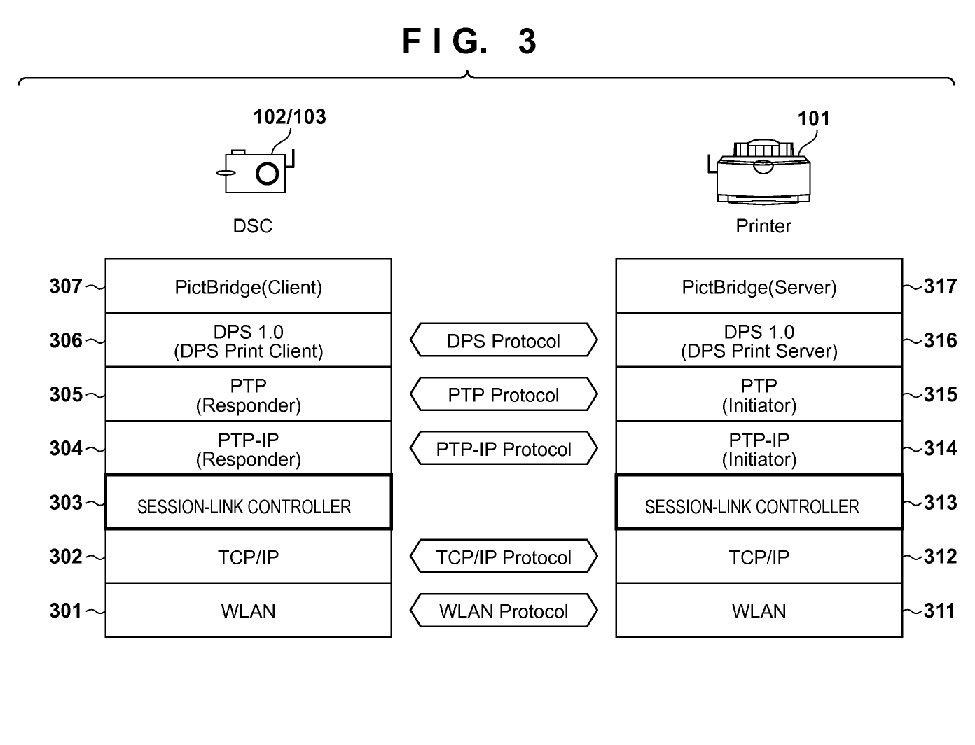

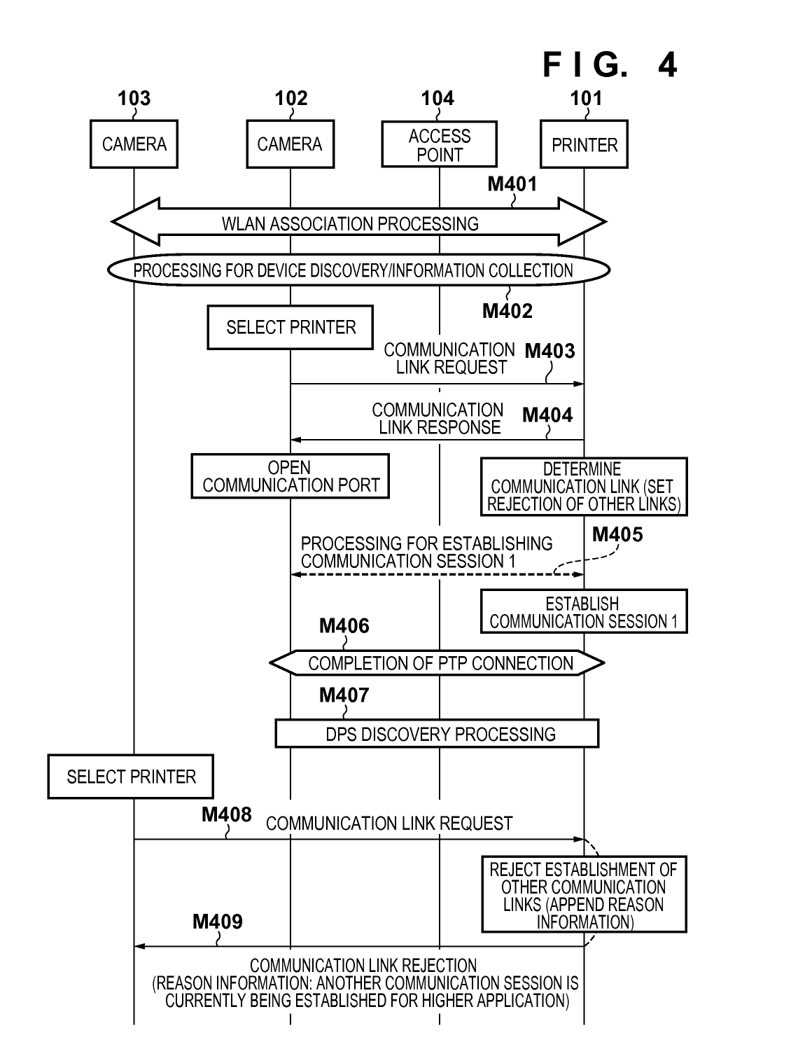

The printer 101, the camera 102 and the camera 103 have TCP/IP as a communication protocol, and uses a UPnP protocol to collect communication apparatus information for distinguishing and identifying communication apparatuses in the wireless network. TCP/IP including this UPnP protocol is a communication protocol for establishing a communication link between the printer 101 and the camera 102, or between the printer 101 and the camera 103. Furthermore, in the present embodiment, session-link controllers (303 and 313 in FIG. 3) are provided to control consistency between a communication session according to PTP/IP and a communication link according to TCP/IP. The aforementioned software is stored in the ROM 203 and executed by the controller 205.

FIG. 3 shows an example of a configuration of protocol layers in the communication apparatuses according to First Embodiment. The following describes protocol layers used in the aforementioned DPS and layers therebelow with reference to FIG. 3, with a focus on the cameras 102 and 103, which are communication apparatuses that transmit image data, and the printer 101, which is a communication apparatus that receives the image data.

Wireless LAN communication protocol parts 301 and 311 handle, for example, data packets conforming to IEEE 802.11 (WLAN protocols). TCP/IP protocol parts 302 and 312 handle IP packets and data packets of transport protocol parts with a UPnP protocol. PTP/IP protocol parts 304 and 314 handle PTP data using data packets of the TCP/IP protocol parts 302 and 312. In particular, the PTP/IP protocol part 304, which is installed on the cameras 102 and 103, has a Responder function of performing passive operations in peer-to-peer communication of DPS. On the other hand, the PTP/IP protocol part 314, which is installed on the printer 101, has an Initiator function of performing active operations in peer-to-peer communication of DPS.

In FIGS. 3, 303 and 313 denote session-link controllers that control consistency between a communication link used by the TCP/IP protocol parts 302 and 312 and a communication session used by the PTP/IP protocol parts 304 and 314. The session-link controller 303 is installed on the cameras 102 and 103 that perform passive operations in peer-to-peer communication of DPS. On the other hand, the session-link controller 313 is installed on the printer 101 that performs active operations in peer-to-peer communication of DPS.

Session protocol parts 305 and 315 implement PTP. The session protocol part 305, which is installed on the cameras 102 and 103, has a Responder function that performs passive operations in peer-to-peer communication of DPS, and handles PTP packets and the like. On the other hand, the session protocol part 315, which is installed on the printer 101, has an Initiator function of performing active operations in peer-to-peer communication of DPS, and handles PTP packets and the like. A DPS protocol part 306, which is installed on the cameras 102 and 103, has a Client function of activating a printing service. On the other hand, a DPS protocol part 316, which is installed on the printer 101, has a Server function of a printing service. An application protocol part 307, which is installed on the cameras 102 and 103, has a Client function of activating a printing service using PictBridge. On the other hand, an application protocol part 317, which is installed on the printer 101, has a Server function of a printing service using PictBridge.

The PC 105 has a function of building a wireless communication link between itself and the printer 101, and printing image data using a second image printing protocol according to a predetermined printing application in an application layer.

In terms of specific software configuration, the printer 101 has a Server function of a printing application, and the PC 105 has a Client function of a printing application. They provide a service by controlling printing in their respective application layers. The printer 101 also has a Line Printer Daemon (LPD) protocol function, which is a protocol indispensable for the printing application. The PC 105 also has a Line Printer Remote (LPR) protocol function. Furthermore, as with the printer 101, the camera 102 and the camera 103, the PC 105 has TCP/IP as a communication protocol for distinguishing and identifying communication apparatuses by using a UPnP protocol for collecting communication apparatus information in the wireless network. TCP/IP including this UPnP protocol is a communication protocol for establishing a communication link between the printer 101 and the PC 105.

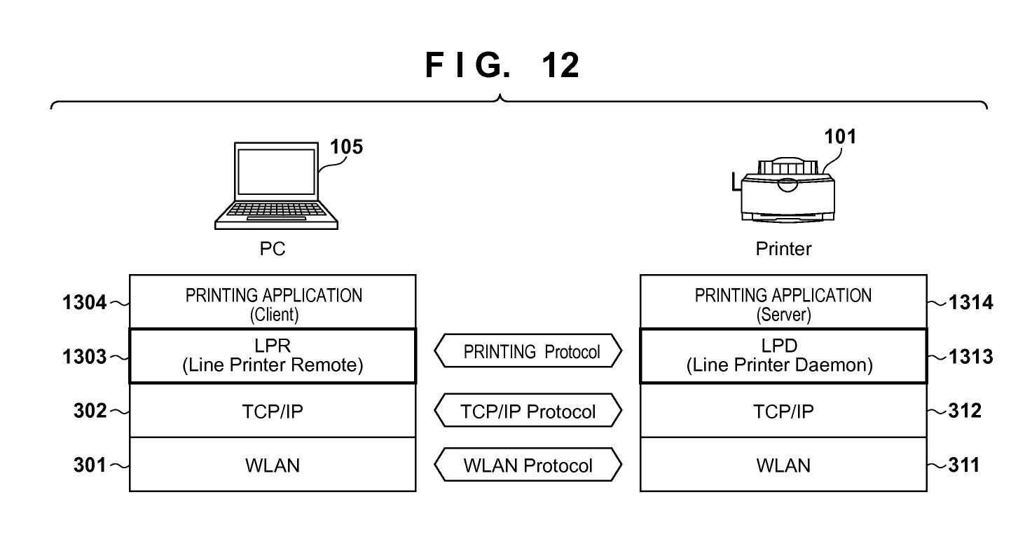

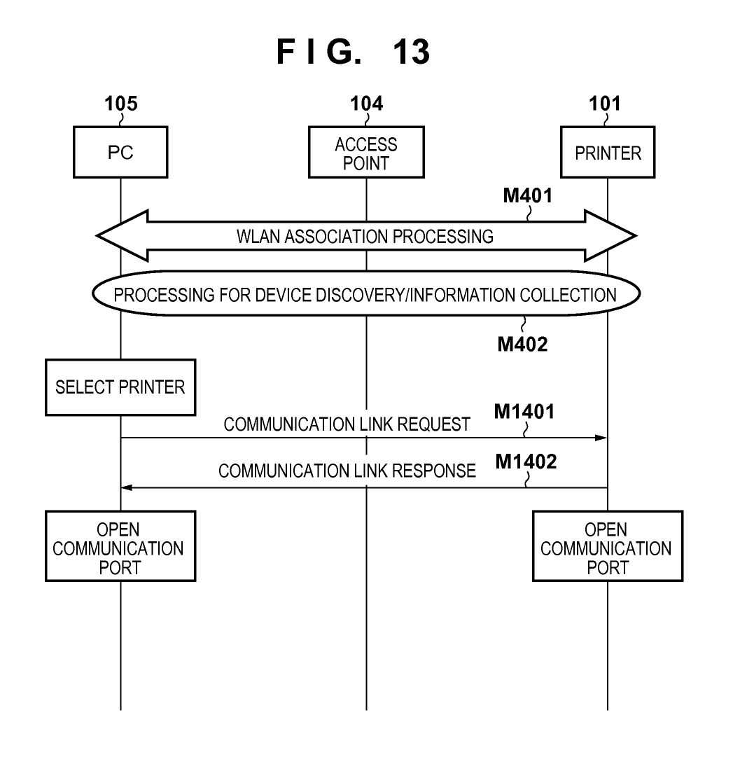

With reference to FIG. 12, the following description describes the PC 105, which is a communication apparatus that outputs image data, and the printer 101, which outputs an image, for each protocol layer used by the aforementioned printing application. The wireless LAN communication protocol parts 301 and 311 and the TCP/IP protocol parts 302 and 312 shown in FIG. 12 are similar to those of the camera 102, the camera 103 and the printer 101 illustrated in FIG. 3, and are therefore omitted from the following description.

In FIG. 12, 1303 denotes an LPR protocol part that handles printing protocol data using data packets of the TCP/IP protocol part 302. It is referred to as an LPR client. In particular the LPR protocol part 1303 has a function of transmitting a print job to a print queue of the printer 101 and is installed on the PC 105. Also, 1313 denotes an LPD protocol part that handles printing protocol data using data packets of the TCP/IP protocol part 312. It is referred to as an LPD server. In particular, the LPD protocol part 1313 has a function of receiving a print job from the PC 105 and is installed on the printer 101.

Furthermore, 1304 is a Client function of a printing application for transmitting printing data to the printer 101 using the LPR protocol part 1303, and is installed on the PC 105. On the other hand, 1314 is a Server function of a printing application for receiving printing data from the PC 105 using the LPD protocol part 1313. It converts the received image data into printing data and spools the received image data. In particular, the Server function 1314 of the printing application is installed on the printer 101.

For simplicity, in the following description, the Client function 1304 of the printing application is referred to as a “printing application (Client)”, and the Server function 1314 of the printing application is referred to as a “printing application (Server)”.

(Operations of System and Apparatuses)

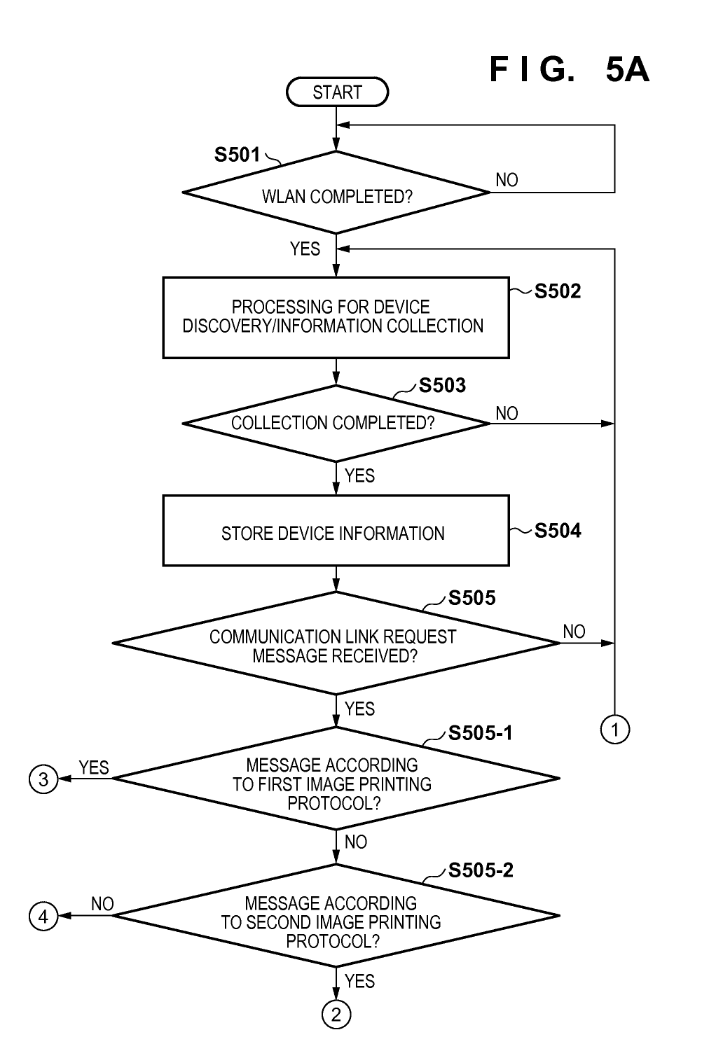

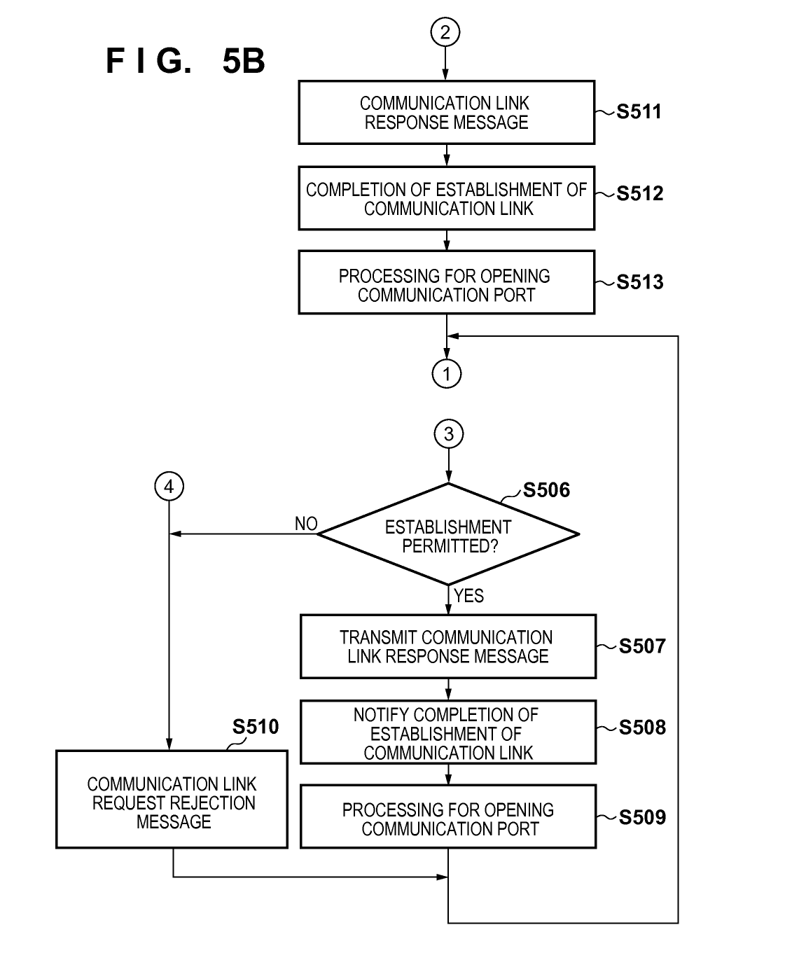

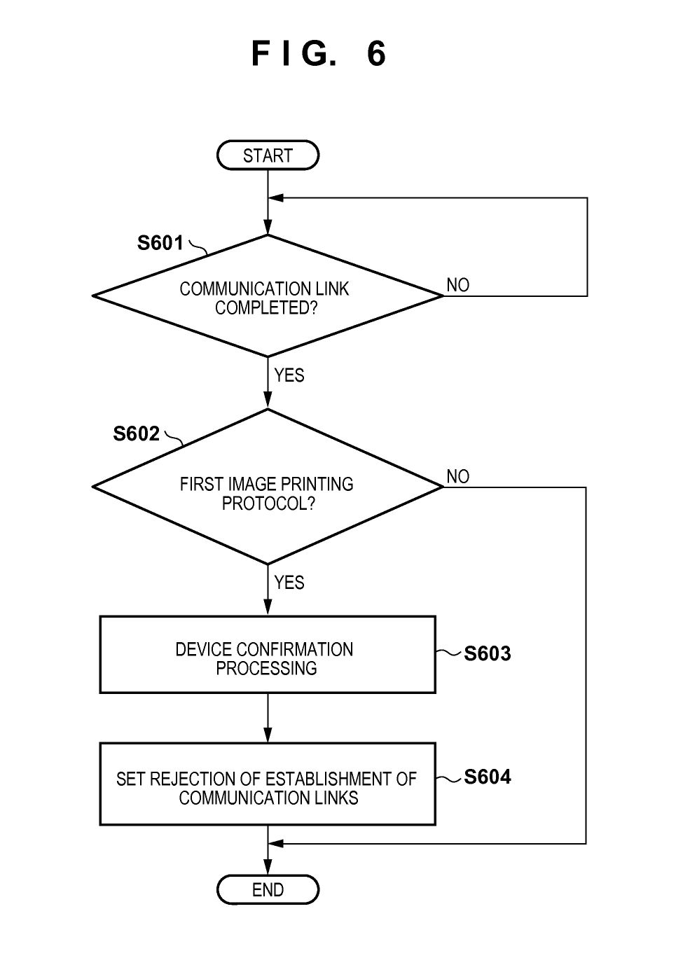

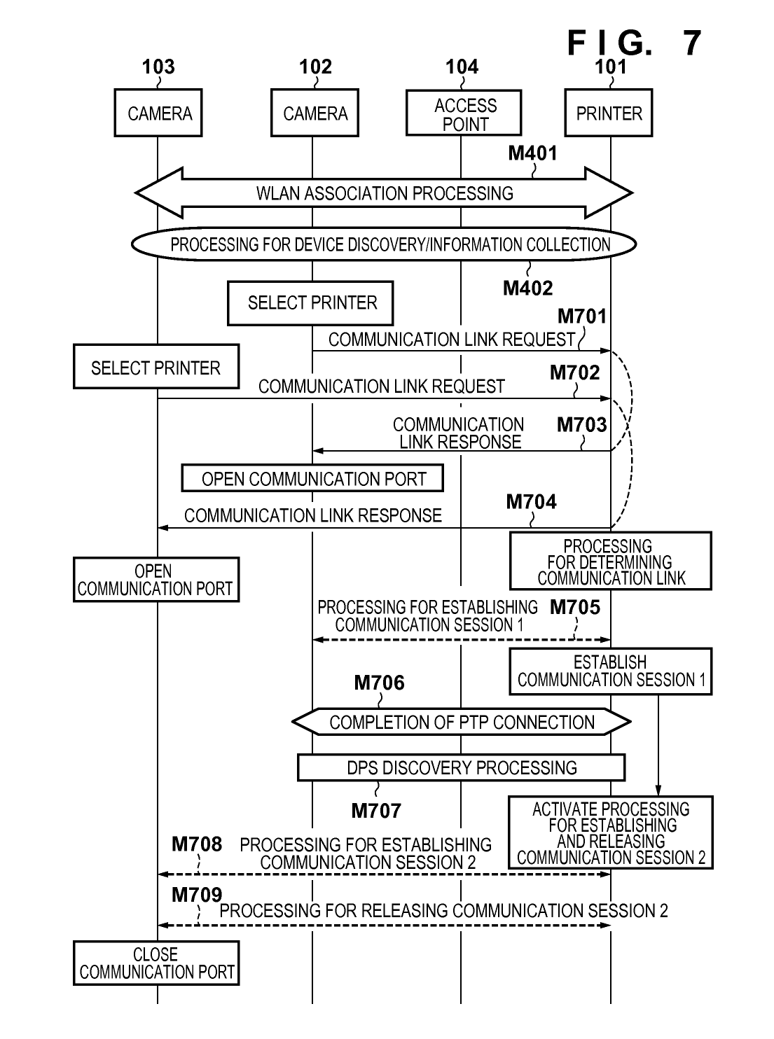

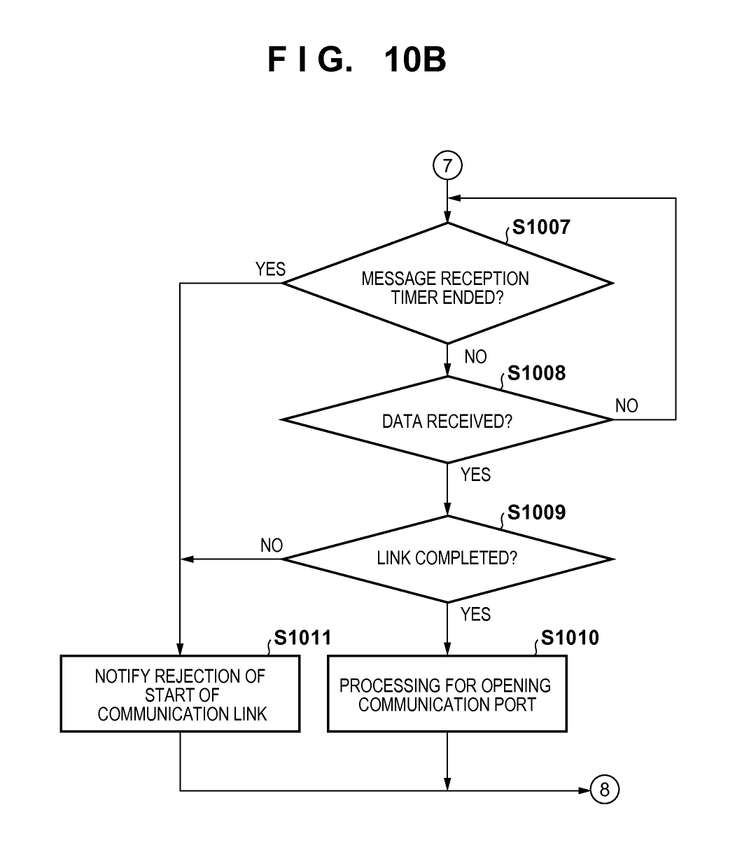

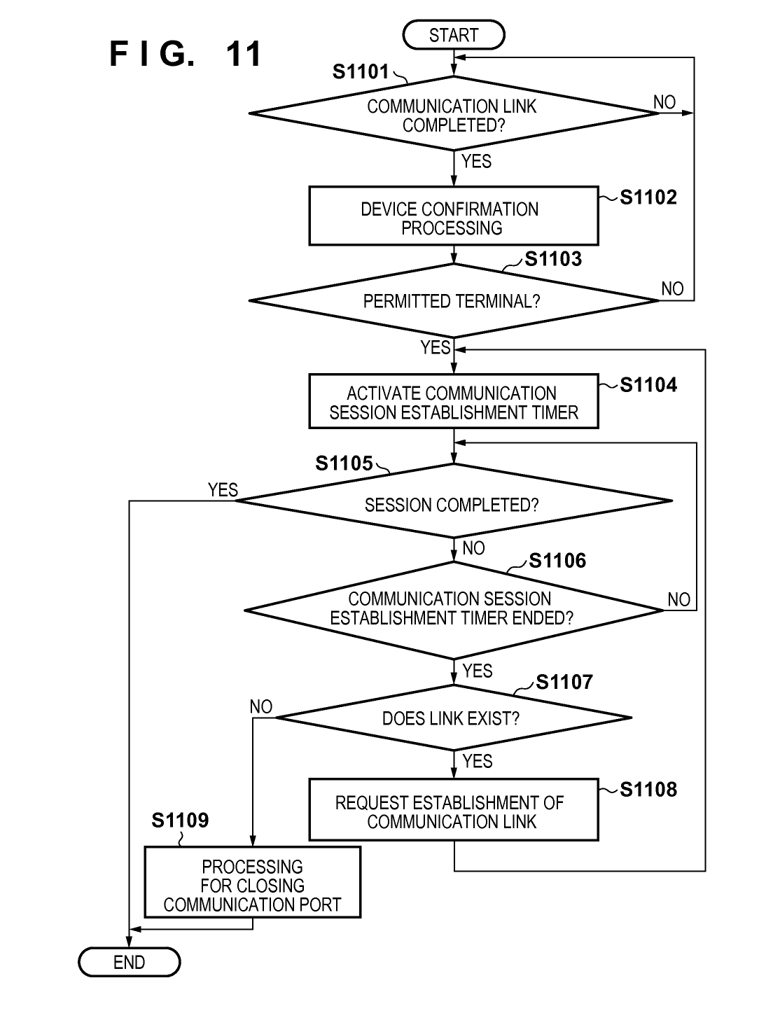

The following description describes the operations of a system including the printer 101, the camera 102, the camera 103, the PC 105 and the access point 104 configured in the above-described manner. FIGS. 4 and 7 are sequence charts of message transmission/reception processing executed by the printer 101, the camera 102, the camera 103 and the access point 104 constituting the communication network according to First Embodiment. FIG. 13 is a sequence chart of message transmission/reception processing executed by the printer 101, the PC 105 and the access point 104 constituting the communication network according to First Embodiment. FIGS. 5A and 5B are flowcharts related to the TCP/IP protocol part 312 of the printer 101 according to First Embodiment. FIG. 6 is a flowchart related to the session-link controller 313 of the printer 101 according to First Embodiment. FIGS. 10A and 10B are flowcharts related to the TCP/IP protocol part 302 of the camera 102, the camera 103 and the PC 105 according to First Embodiment. First, a description is given of common operations performed by the printer 101, the camera 102, the camera 103 and the PC 105 for building a wireless network.

The wireless LAN communication protocol part 311 of the printer 101 executes association processing (M401) for establishing wireless connection with the access point 104. Similarly, the wireless LAN communication protocol parts 301 of the camera 102, the camera 103 and the PC 105 also execute association processing (M401) for establishing wireless connection with the access point 104.

When association has been made with a wireless LAN network (the YES branch of S501), the TCP/IP protocol part 312 of the printer 101 executes discovery processing (M402) for discovering other communication apparatuses existing in that network (S502). Similarly, when association has been made with the wireless LAN network (the YES branch of S1001), the TCP/IP protocol parts 302 of the camera 102, the camera 103 and the PC 105 execute discovery processing (M402) for discovering other communication apparatuses existing in that network (S1002).

Upon completion of the discovery processing (M402), which is collection of device information of communication apparatuses (the YES branch of S503), the TCP/IP protocol part 312 of the printer 101 stores device information of the camera 102, the camera 103 and the PC 105 existing in the network in the RAM 204 (S504). Similarly, also upon completion of the discovery processing (M402), which is collection of device information of communication apparatuses (the YES branch of S1003), the TCP/IP protocol parts 302 of the camera 102, the camera 103 and the PC 105 store device information of the printer 101 existing in the network in the RAMs 204 of the camera 102, the camera 103 and the PC 105 (S1004).

Thereafter, a user of the camera 102 confirms the existence of the printer 101 in the network via the display controller 206 of the camera 102, selects the printer 101, and activates printing of DPS by performing a predetermined user operation on the key input part 207 of the camera 102. Upon detecting this user operation (the YES branch of S1005), the application protocol part 307 of the camera 102 notifies the PTP/IP protocol part 304 of a communication session start request via the DPS protocol part 306 and the session protocol part 305. Upon receiving the communication session start request, the PTP/IP protocol part 304 of the camera 102 notifies the TCP/IP protocol part 302 of the communication session start request via the session-link controller 303.

Under control of the session-link controller 303, the TCP/IP protocol part 302 instructs the wireless LAN communication protocol part 301 to transmit a communication link request message (M403) for requesting the establishment of the communication link 1 to the printer 101, and activates a message reception timer (S1006). The wireless LAN communication protocol part 301 of the camera 102 transmits the communication link request message (M403) to the wireless network managed by the access point 104 via the transmission/reception part 202 and the antenna 201 using the first image printing protocol of the DPS function. In the printer 101, the transmission/reception part 202 receives the communication link request message (M403) from the access point 104 via the antenna 201, and the controller 205 transmits the received data to the wireless LAN communication protocol part 311.

When the wireless LAN communication protocol part 311 of the printer 101 receives the communication link request message (S505), it transmits the received data to the TCP/IP protocol part 312. The TCP/IP protocol part 312 analyzes the received message (S505-1). When the TCP/IP protocol part 312 determines that the received message is a communication link request message according to the first image printing protocol of the DPS function as a result of the analysis (the YES branch of S505-1), it confirms whether or not a response to the received message is permitted (whether or not a communication link can be established) (S506). In the present embodiment, as will be described later in connection with step 5604, whether the response to the communication link request message is permitted or prohibited is registered with the RAM 204. When the response to the communication link request message (M403) is permitted (the YES branch of S506), the processing moves to S507. The TCP/IP protocol part 312 instructs the wireless LAN communication protocol part 311 to return a communication link response message (M404) according to the first image printing protocol to the camera 102 (S507). Note that the communication link response message is an affirmative response message to the request for establishing the communication link 1.

Upon receiving this instruction, the wireless LAN communication protocol part 311 transmits the communication link response message (M404) to the wireless network managed by the access point 104 via the transmission/reception part 202 and the antenna 201. This completes the communication link establishment processing of the printer 101. Subsequently, the TCP/IP protocol part 312 of the printer 101 notifies the session-link controller 313 of completion of the establishment of the communication link (S508), and executes processing for opening a communication port used in a communication session 1 (S509). Processing that follows the NO branch of step S506 (when the establishment of the communication is not permitted) will be described later.

The following description describes the operations of the session-link controller 313 of the printer 101 with reference to FIG. 6. When the session-link controller 313 of the printer 101 is notified of completion of the establishment of the communication link (S508) (the YES branch of S601), it determines the image printing protocol with which the communication link has been established (S602). When the communication link has been established using a communication link request message according to the first image printing protocol (the YES branch of S602), the session-link controller 313 confirms device information of the camera 102 with which the communication link has been established (S603). After confirming the device information, the session-link controller 313 sets the TCP/IP protocol part 312 to prohibit an affirmative response to further communication link request messages in order to reject establishment of subsequent communication links (S604). For example, for use in the aforementioned step S506, the session-link controller 313 registers prohibition of a response to messages of communication link establishment requests with the RAM 204. The session-link controller 313 also notifies the session protocol part 315 of the establishment of the communication link 1 in the IP layer via the PTP/IP protocol part 314. Upon receiving this notification, the session protocol part 315 starts processing (M405) for establishing the communication session 1, which is a PTP session, with the session protocol part 305 of the camera 102 using the communication link 1. In this manner, the communication session 1 is established between the printer 101 and the camera 102, and the TCP/IP protocol part 312 is set to reject other links in accordance with the instruction from the session-link controller 313 to “reject establishment of communication links”. Note that the rejection of connection to other links set in S604 is cancelled when the established link ceases due to, for example, the termination of the communication session.

On the other hand, when the image printing protocol with which the communication link has been established is not the first image printing protocol (the NO branch of S602), the rejection of connection to other links is not set.

After the PTP session has been established (M406), DPS discovery processing for exchanging device information (M407) is executed between the DPS protocol part 316 of the printer 101 and the DPS protocol part 306 of the camera 102. Thereafter, the printing service is started using the first image processing protocol of the application protocol part 307 of the camera 102 and the application protocol part 317 of the printer 101.

On the other hand, when the camera 102 receives the communication link response message (M404) from the printer 101 (the YES branch of S1008) before the message reception timer activated in S1006 ends (the NO branch of S1007), it confirms a message type (S1009). When the received message is the communication link response message (M404) (the YES branch of S1009), the TCP/IP protocol part 302 of the camera 102 notifies the session-link controller 303 of completion of the establishment of the communication link, and completes the communication link establishment processing. Thereafter, the TCP/IP protocol part 302 of the camera 102 executes processing for opening a communication port used in the communication session 1 (S1010) and establishes the communication session 1 with the printer 101 (M405).

This concludes the description of normal operational sequences of the processing for establishing the communication link 1 executed by the TCP/IP protocol parts 302 and 312 and the processing for establishing the communication session 1 executed by the session protocol parts 305 and 315 between the camera 102 and the printer 101. When the message reception timer ends (the YES branch of S1007), the TCP/IP protocol part 302 of the camera 102 executes error processing of notifying the session-link controller 303 of the rejection of the communication link (S1011), and ends the communication link establishment processing.

The following description describes control processing executed by the printer 101 when the camera 103 issues a communication link establishment request to the printer 101 after a communication session has been established between the camera 102 and the printer 101 through the above-described normal operations. In the state where the above communication session 1 has been established, a user of the camera 103 confirms the existence of the printer 101 in the network via the display controller 206, selects the printer 101, and activates printing of DPS by performing an operation on the key input part 207 of the camera 103. As a result of this user operation, the application protocol part 307 of the camera 103 notifies the PTP/IP protocol part 304 of a communication session establishment request via the DPS protocol part 306 and the session protocol part 305.

Upon receiving the communication session establishment request, the PTP/IP protocol part 304 of the camera 103 notifies the TCP/IP protocol part 302 of the communication session establishment request via the session-link controller 303 (S1005 and S1006). That is to say, under control of the session-link controller 303 of the camera 103, the TCP/IP protocol part 302 instructs the wireless LAN communication protocol part 301 to transmit a communication link request message (M408) for requesting the establishment of the communication link 2 to the printer 101 (S1006).

The wireless LAN communication protocol part 301 of the camera 103 transmits the communication link request message (M408) to the wireless network managed by the access point 104 using the first image printing protocol via the transmission/reception part 202 and the antenna 201. In the printer 101, when the transmission/reception part 202 receives this communication link request message (M408) from the access point 104 via the antenna 201, the controller 205 transmits the received data to the wireless LAN communication protocol part 311. The wireless LAN communication protocol part 311 of the printer 101 transmits the received data (message) to the TCP/IP protocol part 312.

In the printer 101, when the TCP/IP protocol part 312 receives the communication link request message (S505), it analyzes the received message (S505-1). When the TCP/IP protocol part 312 determines that the received message is a communication link request message according to the first image printing protocol as a result of the analysis (the YES branch of S505-1), it confirms whether or not a response to the message is permitted with reference to the RAM 204 (S506). As has been mentioned earlier, prohibition of a response to communication link request messages was stored in the RAM 204 when the communication link 1 was established. As a response to the request message (M408) is not permitted (the NO branch of S506), the printer 101 executes processing for returning a rejection message to the camera 103 using the first image printing protocol (S510), the rejection message indicating that the establishment of the communication link 2 is rejected. That is to say, the TCP/IP protocol part 312 of the printer 101 instructs the wireless LAN communication protocol part 311 to transmit a communication link rejection message to the printer 101.

The wireless LAN communication protocol part 311 of the printer 101 transmits the communication link rejection message (M409) to the wireless network managed by the access point 104 via the transmission/reception part 202 and the antenna 201. This completes the message transmission processing. Note that the communication link rejection message is a negative response message to the communication link request. At this time, the camera 103 may be notified of the fact that the printer 101 has already established a communication session with another communication apparatus, namely the camera 102, as information appended to the communication link rejection message (M409).

In the camera 103, when the transmission/reception part 202 receives the communication link rejection message (M409) from the access point 104 via the antenna 201, the controller 205 transmits the received data to the wireless LAN communication protocol part 311. The wireless LAN communication protocol part 301 of the camera 103 transmits the received data (message) to the TCP/IP protocol part 302.

When the TCP/IP protocol part 302 of the camera 103 receives the message (M409) (the YES branch of S1008) before the message reception timer ends (the NO branch of S1007), it analyzes the message to confirm the type thereof (S1009). In the present example, as the message is the communication link rejection message (the NO branch of S1009), the TCP/IP protocol part 302 notifies the session-link controller 303 of the rejection of the communication link (S1011). The session-link controller 303 also notifies the DPS protocol part 306 of the rejection of the establishment of the communication link in the IP layer via the PTP/IP protocol part 304 and the session protocol part 305.

Thereafter, under control of the controller 205, the DPS protocol part 306 of the camera 103 sends, to the user who activated the printing service with the camera 103, reason information (indicating, for example, a communication session has already been established by another device) via the display controller 206 (S1011). This reason information is appended to the communication link rejection message (M409) by the printer 101.

This concludes the description of operational sequences for rejecting the establishment of the communication link 2 between the TCP/IP protocol parts of the camera 103 and the printer 101. Note that S501 to S510 and S601 to S604 are processing programs stored in the ROM 203 of the printer 101, and S1001 to S1011 are processing programs stored in the ROMs 203 of the cameras 102 and 103.

Through the aforementioned operations, a communication link can be established between the camera 102 and the printer 101 in one-to-one correspondence with one communication session for which the first image printing protocol of DPS is used, even when a plurality of communication links have been activated by the cameras 102 and 103. That is to say, when a communication session has been established using one established communication link, establishment of communication sessions other than the communication session using that one communication link is restricted. This restriction prevents, for example, inconsistency in session management caused by a situation in which a plurality of wireless communication links can be established in layers below PictBridge as opposed to the number of sessions that can be managed by PictBridge being one. Furthermore, as the establishment of the communication link is rejected, cameras do not initiate processing for opening a communication port. This prevents a situation in which communication is left in an open state.

Note that the session-link controller 313 of the printer 101 is notified of the completion of establishment of the communication link by the TCP/IP protocol part 312 (the YES branch of S601), and confirms the device information of the camera 102. Based on this device information, the session-link controller 313 confirms whether there are no problems for the device with which the communication link has been set to act as a Client apparatus of DPS. Here, the session-link controller 313 may receive a criterion (device information) for determining this device from a processor that is higher than itself. For example, the session-link controller 313 may determine whether or not to prohibit establishment of other links based on apparatus information specified by a processor that is higher than itself and on the device information of the camera 102 with which the communication link has been established. Examples of such a higher processor that provides the device information include the PTP/IP protocol part 314, the session protocol part 315, the DPS protocol part 316 and the application protocol part 317.

As has been described above, when the TCP/IP protocol part 312 determines that the received message is a communication link request message according to the first communication protocol (the YES branches of S505 and S505-1), it confirms whether or not a response to the message is permitted (S506). Whether the response is permitted or prohibited is stored in the RAM 204. When the response to the communication link request message (M403) is permitted (the YES branch of S506), the TCP/IP protocol part 312 transmits the communication link response message to the camera 102. However, information that is referred to for determining whether to permit or prohibit a communication link establishment request is not limited to the above. For example, it is possible to determine whether or not the communication link is permitted to be started by further referring to a history of previous communication stored in the RAM 204. In this case, for example, the communication link establishment request may be permitted when it is made by a communication apparatus that performed the last communication. Furthermore, in order to equalize opportunities to establish communication links, a response may be permitted when the communication apparatus with which the communication link is currently being established performed the last communication and the communication link request has been issued from another communication apparatus. Note that in the aforementioned control, when the establishment of a communication link that is different from the communication link that is currently being established is permitted, the communication link that is currently being established and its communication session are forcibly terminated.

The following description describes the operations of the PC 105, the printer 101 and the access point 104 with reference to FIG. 13. After the PC 105 has established wireless LAN communication (M401, S1001), searched for the devices connected to the network and collected the device information in the network (M402, S1002, S1003, S1004), a user of the PC 105 can confirm the existence of the printer 101 in the network on a liquid crystal display of the PC 105. In order to print contents, the user activates the printing application (Client) 1304 and selects the printer 101 by performing operations on a keyboard or a mouse of the PC 105 (S1005).

As a result of this user operation, the printing application (Client) 1304 of the PC 105 notifies the TCP/IP protocol part 302 of a communication session establishment request via the LPR protocol part 1303. Under control of the LPR protocol part 1303, the TCP/IP protocol part 302 instructs the wireless LAN communication protocol part 301 to transmit a communication link request message (M1401) for requesting the establishment of the communication link 3 to the printer 101, and activates a response message reception timer.

The wireless LAN communication protocol part 301 of the PC 105 transmits the communication link request message (M1401) to the wireless network managed by the access point 104 using the second image printing protocol (S1006).

When the printer 101 receives the communication link request message (M1401) from the access point 104 (S505), the controller 205 transmits the received data to the wireless LAN communication protocol part 311. The wireless LAN communication protocol part 311 of the printer 101 transmits the received data to the TCP/IP protocol part 312, and the TCP/IP protocol part 312 analyzes the received data (S505-1 and S505-2). When the TCP/IP protocol part 312 determines that the message is a communication link request message (M1401) according to the second image printing protocol (the YES branches of S505-1 and S505-2), it instructs the wireless LAN communication protocol part 311 to transmit a communication link response message (M1402) to the PC 105.

The wireless LAN communication protocol part 311 transmits the communication link response message (M1402) according to the second image printing protocol to the wireless network managed by the access point 104. This completes the communication link establishment processing of the printer 101 (S511 and S512). The TCP/IP protocol part 312 of the printer 101 notifies the LPD protocol part 1313 that the communication link 3 has been established, and executes processing for opening a communication port that is subsequently used by the LPD protocol part 1313 when receiving print data (S513).

On the other hand, in the PC 105, when the wireless LAN communication protocol part 301 receives the communication link response message (M1402) from the printer 101, the TCP/IP protocol part 302 is notified to that effect. When the TCP/IP protocol part 302 receives the communication link response message (M1402) before the response message reception timer that was activated upon transmission of the communication link request message (M1401) ends, it stops the response timer (the NO branch of S1007, the YES branch of S1008).

Thereafter, the TCP/IP protocol part 302 of the PC 105 notifies the LPR protocol part 1303 of the completion of the establishment of the communication link 3 (S1009). The TCP/IP protocol part 302 executes processing for opening a communication port that is subsequently used by the LPR protocol part 1303 when transmitting print data. This completes the processing for establishing the communication link 3 (S1010). When the response message reception timer ends, the TCP/IP protocol part 302 of the PC 105 executes error processing of notifying the LPR protocol part 1303 of the failure of the establishment of the communication link 3, and ends the processing for establishing the communication link 3.

This concludes the description of normal operational sequences of processing for establishing the communication link 3 executed by the TCP/IP protocol parts that are used by the LPR protocol part 1303 and the LPD protocol part 1313, which represent a printing protocol, of the PC 105 and the printer 101.

### Second Embodiment

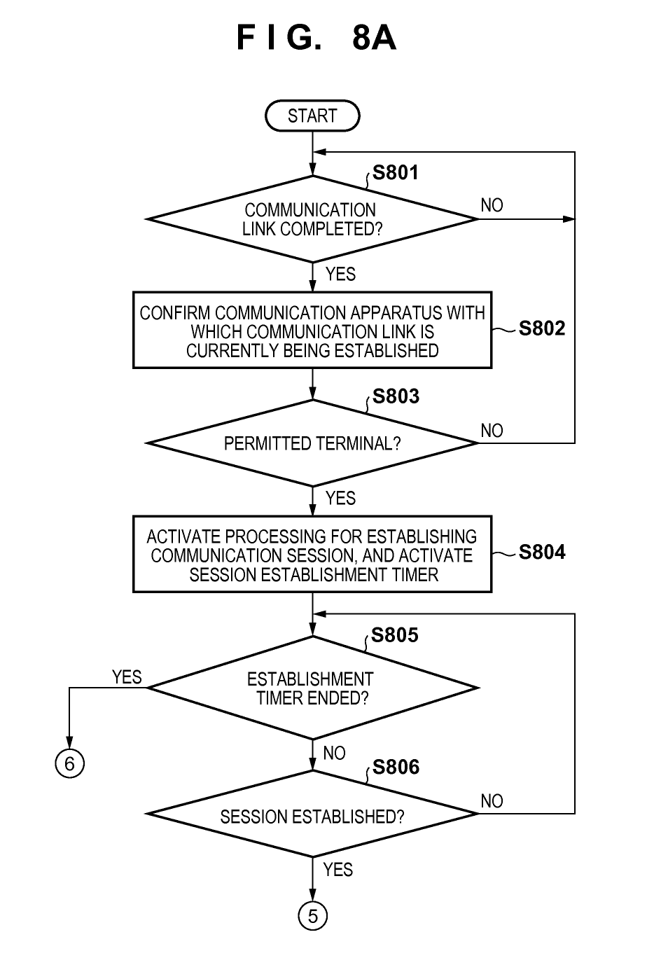

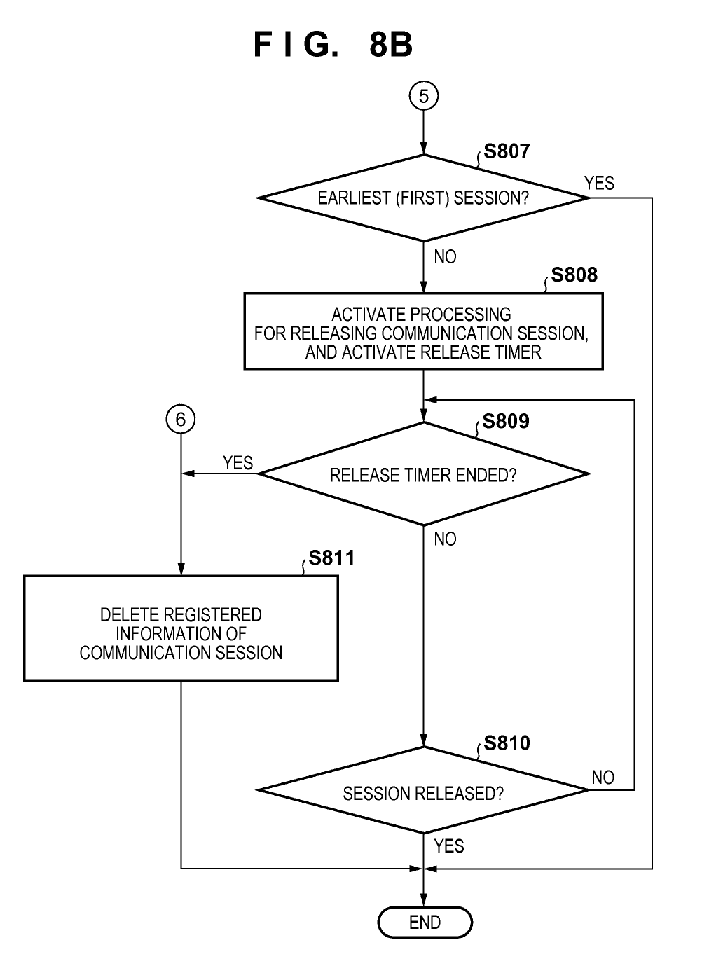

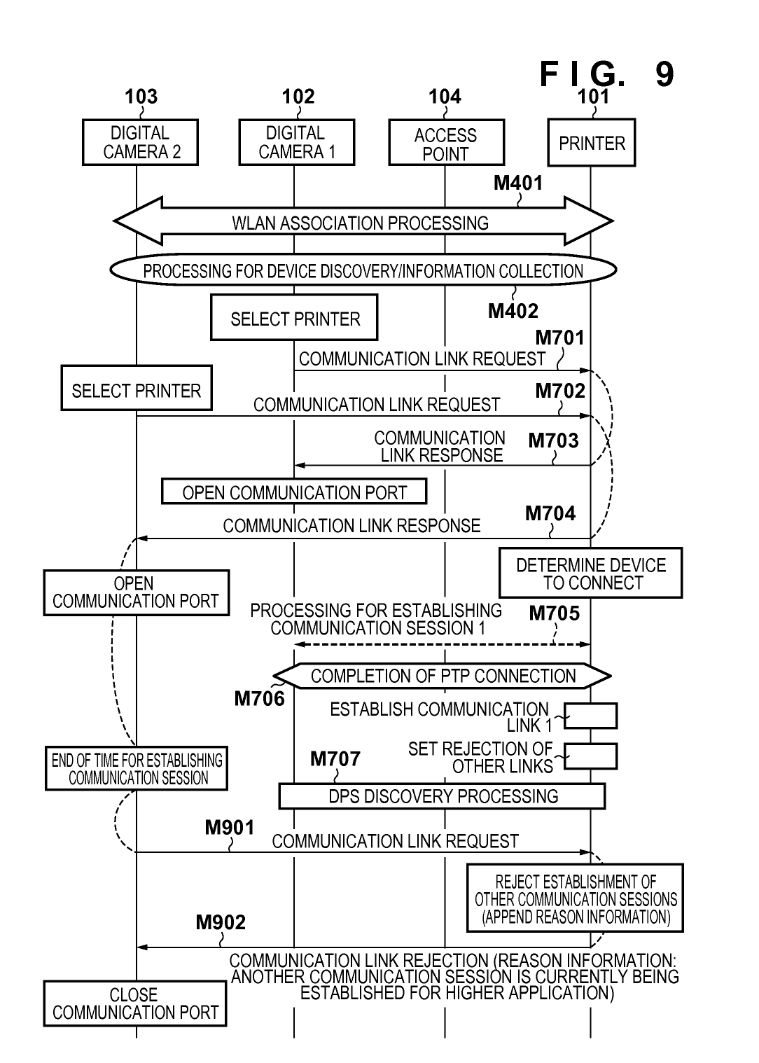

First Embodiment has described the configuration in which, when a link has already been established, establishment of subsequent links is rejected. However, for example, when the cameras 102 and 103 issue communication link requests substantially at the same time, there is a possibility that two communication ports be opened as a result of the printer 101 generating two links in response to these two requests. Even under such a circumstance, Second Embodiment maintains one-to-one correspondence between a communication link and a communication session. Second Embodiment described below is an extension of First Embodiment. The following description describes control procedures performed by wireless communication apparatuses, which represent the feature of Second Embodiment, with reference to FIGS. 7 and 8. Note that the following description describes matters that differ from First Embodiment. FIG. 7 is a sequence chart of message transmission/reception processing executed by the printer 101, the camera 102, the camera 103 and the access point 104 constituting the communication network according to Second Embodiment. FIGS. 8A and 8B are flowcharts related to the session-link controller 313 of the printer 101 according to Second Embodiment.

FIG. 7 illustrates the operations for the case where a user of the camera 102 and a user of the camera 103 activate the printing service substantially at the same time. Note that M401 and M402 of the operational sequence related to the printer 101, the camera 102 and the camera 103 are similar to those in First Embodiment. First, a description is given of the operations related to the camera 102 and the printer 101.

When the TCP/IP protocol part 312 of the printer 101 receives a communication link request message (M701) from the camera 102, it returns a communication link response message (M703) to the camera 102 and establishes a communication link 1. At this time, the TCP/IP protocol part 312 notifies the session-link controller 313 of the establishment of the communication link 1 using completed event information for the communication link 1 including device information of the camera 102.

When the session-link controller 313 receives the completed event information for the communication link 1 (the YES branch of S801), it confirms the device information of the camera 102 with which the TCP/IP protocol part 312 has established the communication link 1 (S802). When the camera 102 is a device (permitted device) that is permitted to establish a communication session with the printer 101 (the YES branch of S803), the session-link controller 313 notifies the session protocol part 315 of the existence of the usable communication link 1 via the PTP/IP protocol part 314 (S804). At the same time as this notification, the session-link controller 313 also activates a session establishment timer to manage communication session establishment processing executed by the PTP/IP protocol part 314 and the session protocol part 315.

Thereafter, the session protocol part 315 starts processing (M705) for establishing a communication session 1, which is a PTP session, with the session protocol part 305 of the camera 102 using the communication link 1. Subsequently, the session protocol part 315 of the printer 101 establishes the PTP session, namely the communication session 1 (M706), and discovery processing for exchanging device information is executed between the DPS protocol part 316 and the DPS protocol part 306 of the camera 102 (M707).

When the session-link controller 313 detects the establishment of the communication session 1 (the YES branch of S806) before the session establishment timer associated with the processing (M705) for establishing the communication session 1 ends (the NO branch of S805), it confirms the order of the establishment of the communication session 1. When the communication session 1 is the earliest (first) communication session (the YES branch of S807), the session-link controller 313 ends the processing related to the communication session. As a result, the PTP session is established (M706). Thereafter, DPS discovery processing for exchanging device information is executed between the DPS protocol part 316 of the printer 101 and the DPS protocol part 306 of the camera 102 (M707). Then, the printing service is started using PictBridge of the application protocol part 307 of the camera 102 and the application protocol part 317 of the printer 101. When the session establishment timer ends (the YES branch of S805), the session-link controller 313 deletes registered information related to the communication session that is currently being established (S811) and ends the processing.

A description is now given of the operations related to the camera 103 and the printer 101. When the TCP/IP protocol part 312 of the printer 101 receives a communication link request message (M702) from the camera 103, it returns a communication link response message (M704) to the camera 103 and establishes a communication link 2. The TCP/IP protocol part 302 of the camera 103 notifies the session-link controller 303 of the establishment of the communication link 2 using completed event information for the communication link 2 including device information, and executes processing for opening a communication port used in a communication session 2 (S1010).

The opened communication port is used for communication between the PTP/IP protocol part 304 of the camera 103 (Responder) and the PTP/IP protocol part 314 of the printer 101 (Initiator), and waits for a message transmitted from the Initiator. On the other hand, the TCP/IP protocol part 312 of the printer 101 notifies the session-link controller 313 of the establishment of the communication link 2 using completed event information for the communication link 2 including device information of the camera 103.

When the session-link controller 313 receives the completed event information for the communication link 2 (the YES branch of S801), it confirms the device information of the camera 103 with which the TCP/IP protocol part 312 has established the communication link 2 (S802). When the camera 103 is permitted to establish a communication session with the printer 101 (the YES branch of S803), the session-link controller 313 notifies the session protocol part 315 of the existence of the usable communication link 2 via the PTP/IP protocol part 314.

That is to say, the session-link controller 313 activates communication session establishment processing of the PTP/IP protocol part 314 and the session protocol part 315, and activates a session establishment timer (S804). The session protocol part 315 starts processing (M708) for establishing the communication session 2, which is a PTP session, with the session protocol part 305 of the camera 103 using the communication link 2.

The aforementioned procedure between the session-link controller 313 and the camera 102 already established the communication session 1 (the YES branch of S806) before the end of the session establishment timer associated with the processing (M705) for establishing the communication session 1 (the NO branch of S805). Because the communication session 2 is not the earliest (first) communication session (the NO branch of S807), the session-link controller 313 activates processing for releasing the communication session 2 executed by the session protocol part 315 via the PTP/IP protocol part 314 (S808). At this time, the session-link controller 313 also activates a session release timer to manage the processing for releasing the communication session 2 executed by the PTP/IP protocol part 314 and the session protocol part 315 (S808). The session protocol part 315 then starts processing (M709) for releasing the communication session 2, which is a PTP session, between itself and the session protocol part 305 of the camera 103. By establishing and releasing the communication session 2 in the aforementioned manner, the camera 103 can close a port through a normal procedure. Although not shown in the figures, the printer 101 also closes a communication port that has been opened for use in the communication session 2 (communication link 2) subjected to the release processing.

When the session-link controller 313 detects the release of the communication session 2 (M709) (the YES branch of S810) before the session release timer ends (the NO branch of S809), it stops the session release timer and ends the processing (the YES branch of S810). When the session release timer ends (the YES branch of S809), the session-link controller 313 deletes registered information related to the communication session 2 that is currently being established (S811) and ends the processing.

After the processing for releasing the communication session 2 is completed, the session protocol part 305 of the camera 103 notifies the session-link controller 303 of the release of the communication session 2 via the PTP/IP protocol part 304. As the communication session 2 has been released, the session-link controller 303 executes processing for closing the communication port to be used in the communication session 2 via the TCP/IP protocol part 302 so as to end the use of the communication link 2.

This concludes the description of operational sequences for establishing and releasing a communication session between the session protocol parts of the camera 103 and the printer 101 in Second Embodiment. Note that S801 to S811 are processing programs stored in the ROM 203 of the printer 101.

Through the above-described operations, when a communication session has been established using one established communication link, establishment of communication sessions other than this communication session using one established communication link is prohibited. Therefore, even when the cameras 102 and 103 activate a plurality of communication links at the same time, a communication link can be consistently established between the camera 102 and the printer 101 in one-to-one correspondence with a communication session used in DPS. Furthermore, the above-described operations prevent a situation in which, after a communication session that can be used in DPS is established between the camera 102 and the printer 101, a communication port of the camera 103 with which a communication session has been released is left in an open state. Closing of unused communication ports of digital cameras makes it possible to reliably prevent such an open state. This improves the network security. For example, assume the case where the communication link request message (M702) is issued immediately before the communication link 1 is established. In this case, with the configuration of First Embodiment, the session-link controller 313 may not be able to set the rejection of establishment of communication links (S604) in time, and therefore the communication link 1 and the communication link 2 may be established. On the other hand, even in such an event, Second Embodiment guarantees that a communication link be consistently established between the camera 102 and the printer 101 in one-to-one correspondence with a communication session used in DPS. The configuration of First Embodiment and the configuration of Second Embodiment may be combined.

Note that in Second Embodiment, the procedure between the session-link controller 313 and the camera 102 established the communication session 1 (the YES branch of 5806) before the end of the establishment timer associated with the processing (M705) for establishing the communication 1 (the NO branch of S805). As a result, when determining the establishment of the communication session 2, the communication session 2 is not the earliest (first) communication session (the NO branch of S807). This leads to activation of processing for releasing the communication session 2 executed by the session protocol part 315 via the PTP/IP protocol part 314. However, the configuration of Second Embodiment is not limited in this way. For example, it is possible to determine which one of the communication sessions 1 and 2 is selected (which one of the sessions is established and released) by further referring to a communication history and the like, regardless of the order of establishment of communication sessions. In this case, the session-link controller 313 may send, to a processor that is higher than itself, device information of the communication apparatus that has requested the establishment of a session, and this processor may determine the establishment/release of the session. A result of this determination may be notified to the session-link controller 313, and the session-link controller 313 may release the communication session with the camera 102 or 103 based on the notified result of determination. Examples of such a higher processor include the PTP/IP protocol part 314, the session protocol part 315, the DPS protocol part 316 and the application protocol part 317.

### Third Embodiment

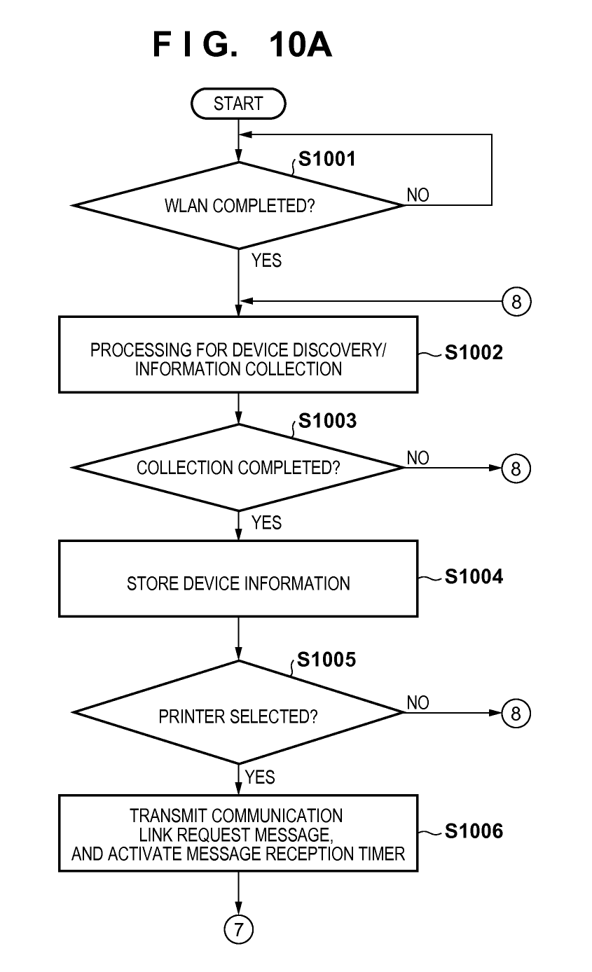

Third Embodiment is an extension of First Embodiment and Second Embodiment. The following description describes control procedures performed by wireless communication apparatuses, which represent the feature of Third Embodiment, with reference to FIGS. 9, 10 and 11. Note that the following description describes matters that differ from First Embodiment and Second Embodiment. FIG. 9 is a sequence chart of message transmission/reception processing executed by the printer 101, the camera 102, the camera 103 and the access point 104 constituting the communication network according to Third Embodiment. FIGS. 10A and 10B are flowcharts related to the TCP/IP protocol part 302 of the camera 103 according to the present embodiment. FIG. 11 is a flowchart related to the session-link controller 303 of the camera 103 according to Third Embodiment.

The following description describes the operations for the case where a user of the camera 102 and a user of the camera 103 activate the printing service substantially at the same time. Note that M401, M402, M702, M703 and M705 to M707 of the operational sequence related to the printer 101, the camera 102 and the camera 103 are similar to those in Second Embodiment.

In particular, the following description describes the operations of the camera 103 which represent the feature of Third Embodiment the most. The TCP/IP protocol part 302 of the camera 103 activates a message reception timer after transmitting a communication link request message (M702) (S1006). When a message (M704) is received from the printer 101 (the YES branch of S1008) before the activated message reception timer ends (the NO branch of S1007), the processing moves to step S1009. When the received message is the communication link response message (M704) (the YES branch of S1009), the TCP/IP protocol part 302 of the camera 103 notifies the session-link controller 303 of the completion of the establishment of the communication link 2, and completes the processing for establishing the communication link 2. The TCP/IP protocol part 302 also notifies the session-link controller 303 of the establishment of the communication link 2 using completed event information for the communication link 2 including device information of the camera 103, and executes processing for opening a communication port used in a communication session 2 (S1010). The communication port is used for communication between the PTP/IP protocol part 304 of the camera 103 (Responder) and the PTP/IP protocol part 314 of the printer 101 (Initiator), and waits for a message transmitted from the Initiator.

When the session-link controller 313 of the camera 103 receives the completed event information for the communication link 2 (the YES branch of S1101), it confirms the device information of the camera 103 with which the TCP/IP protocol part 302 has established the communication link 2 (S1102). When the camera 103 is a device that is permitted to establish a communication session with the printer 101 (the YES branch of S1103), the session-link controller 303 notifies the session protocol part 305 of the existence of the usable communication link 2 via the PTP/IP protocol part 304. The session-link controller 303 then activates a communication session establishment timer to manage communication session establishment processing of the PTP/IP protocol part 304 and the session protocol part 305 (S1104).

A session protocol of PTP is activated by the printer 101, which is the Initiator. Therefore, the session protocol part 305 of the camera 103, which is the Responder function, waits for activation of processing for establishing the PTP session which is activated by the session protocol part 315 of the printer 101 using the communication link 2.

In the camera 102, the establishment of the communication session 1 is detected (the YES branch of S1105) before the communication session establishment timer ends (the NO branch of S1106), and the session-link controller 303 determines that the communication session establishment processing has been completed in a normal way and ends the processing. On the other hand, as has been described in Second Embodiment, the establishment of the communication session corresponding to the communication link 2 is rejected. Hence, the camera 103 cannot establish the communication session even after a predetermined time period specified by the communication session establishment timer has elapsed since the establishment of the communication link. That is to say, in the camera 103, the communication session is not established (the NO branch of S1105) even when the communication session establishment timer has ended (the YES branch of S1106). Therefore, the session-link controller 303 determines whether or not the communication link 2 still exists, and when the communication link 2 still exists (the YES branch of S1107), issues a communication link request to the printer 101 again (S1108). That is to say, the session-link controller 303 instructs the wireless LAN communication protocol part 301 to transmit a communication link request message (M901) to the printer 101 again via the TCP/IP protocol part 302. The session-link controller 303 then re-activates the communication session establishment timer (S1104). Thereafter, the session-link controller 303 executes the processes of S1104 to S1108.

Through the above-described processing, the wireless LAN communication protocol part 301 of the camera 103 transmits the communication link request message (M901) to the wireless network managed by the access point 104 via the transmission/reception part 202 and the antenna 201 again. Specific operations related to the communication link request message (M901) and a communication link rejection message (M902), which is a response message to the communication link request message (M901), are respectively similar to M408 and M409 described in First Embodiment. That is to say, the printer 101 that has received the communication link request message transmits the communication link rejection message (M902) (S510) because it has already established another link. At this time, the state of establishment of the communication link 2 in the printer 101 is dissolved.

When the camera 103 receives the communication link rejection message (M902) from the printer 101 while attempting to re-establish the communication link 2 (the YES branch of S1008), the TCP/IP protocol part 302 analyzes the message (S1009). When the TCP/IP protocol part 302 determines that the received message is the communication link rejection message (the NO branch of S1009), it notifies the session-link controller 303 of the rejection of the communication link 2 (S1011) and deletes management information related to the communication link 2.

When the communication session establishment timer ends while the session-link controller 303 is executing the processes of S1104 to S1108 (the YES branch of S1106), the session-link controller 303 confirms the state of establishment of the communication link 2 again (S1107). As the management information related to the communication link 2 was deleted in the aforementioned S1011, it is determined that the communication link 2 does not exist (the NO branch of S1107). Therefore, the session-link controller 303 ends the communication session establishment processing, and executes processing for closing a communication port to be used in the communication session 2 via the TCP/IP protocol part 302 (S1109). Note that S1101 to S1109 are processing programs stored in the ROM 203 of the camera 103.

Through the above-described operations, even when a plurality of communication links are activated at the same time, a communication link can be consistently established in one-to-one correspondence with a communication session used in DPS. That is to say, when a communication session has been established using one established communication link, establishment of communication sessions other than this communication session using one established communication link is prohibited. Furthermore, the above-described operations prevent a situation in which, after a communication session that can be used in DPS is established between the camera 102 and the printer 101, a communication port of the camera 103 that has not yet established a communication session is left in an open state.

### Other Embodiments

In the above embodiments, the session-link controller 313 of the printer 101 and the session-link controllers 303 of the cameras 102 and 103 are located between the TCP/IP protocol parts and the PTP/IP protocol parts. Alternatively, the session-link controllers 303 and 313 may constitute a part of the TCP/IP protocol parts 302 and 312, which are processors lower than themselves. Similarly, the session-link controllers 303 and 313 may constitute a part of the PTP/IP protocol parts 304 and 314, which are processors higher than themselves.

The above embodiments have described the operations of the system and apparatuses based on the infrastructure network shown in FIG. 1A including the printer 101, the camera 102, the camera 103 and the access point 104. These operations are similarly realized in the ad-hoc network shown in FIG. 1B constituted by the printer 101, the camera 102 and the camera 103. Although the first image printing protocol limits the number of communication sessions to one in the above embodiments, the number of communication sessions may be two or more. That is to say, it is possible to reject establishment of further sessions using the methods described in the above embodiments after a predetermined number of (one or more) communication sessions have been established.

As set forth above, the above embodiments can achieve consistency between a communication session managed by communication protocol software and a communication session managed by a wireless link processor that can establish a plurality of links, and therefore enable easy session management.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2011-246861, filed Nov. 10, 2011, and 2012-194409, filed Sep. 4, 2012, which are hereby incorporated by reference herein in their entirety.

What is claimed is:

1. A communication apparatus comprising:
a link establishment unit configured to establish a communication link with another communication apparatus;
a session establishment unit configured to establish a communication session with another communication apparatus using a communication link established by the link establishment unit; and
a control unit configured to, after the session establishment unit has established a predetermined number of communication sessions, restrict communication sessions other than the established communication sessions.

2. The apparatus according to claim 1, wherein
when the session establishment unit has established the predetermined number of communication sessions, the control unit indicates establishment rejection for rejecting establishment of other communication links to the link establishment unit, and
upon receiving a message requesting establishment of a communication link, the link establishment unit establishes the communication link when the control unit has not indicated the establishment rejection thereto, and rejects the establishment of the communication link when the control unit has indicated the establishment rejection thereto.

3. The apparatus according to claim 1, wherein
when a communication session has been established with a specific communication apparatus, the control unit restricts establishment of other communication links by the link establishment unit.

4. The apparatus according to claim 1, wherein
the control unit sets restriction of communication sessions other than the established communication sessions in accordance with a protocol used in transmission of a message requesting establishment of a communication link.

5. The apparatus according to claim 1, wherein
the control unit includes a releasing unit configured to, when a communication session is already established using the communication link at the time of establishment of a new communication session, release the new communication session.

6. The apparatus according to claim 1, wherein
the control unit includes a releasing unit configured to, when a communication session is already established using the communication link at the time of establishment of a new communication session, select and release one of the communication sessions based on device information of communication apparatuses with which the communication sessions have been established.

7. The apparatus according to claim 5, further comprising
a closing unit configured to close a communication port used in a communication session released by the releasing unit.

8. A communication apparatus comprising:
an opening unit configured to open a communication port when a communication link has been established with another communication apparatus in response to a request issued to establish the communication link;
a session establishment unit configured to establish a communication session with said another communication apparatus using the communication link established with said another communication apparatus;
a determination unit configured to determine whether or not the session establishment unit has established the communication session with said another communication apparatus before the elapse of a predetermined time period since the establishment of the communication link;
a request unit configured to, when the predetermined time period has elapsed without the session establishment unit establishing the communication session, re-request said another communication apparatus to establish a communication link; and
a closing unit configured to close the communication port when rejection of link establishment has been notified by said another communication apparatus in response to the re-request made by the request unit.

9. A communication system including a first communication apparatus and a second communication apparatus that respectively perform active operations and passive operations using a communication protocol, the communication system comprising:
a link establishment unit configured to establish a communication link between the first communication apparatus and the second communication apparatus;
a session establishment unit configured to establish a communication session between the first communication apparatus and the second communication apparatus using the communication link established by the link establishment unit; and
a control unit configured to, when the session establishment unit has established the communication session using the communication link established by the link establishment unit, restrict establishment of communication sessions other than the communication session using the communication link.

10. A control method for a communication apparatus, comprising:
a link establishment step of establishing a communication link with another communication apparatus;
a session establishment step of establishing a communication session with said another communication apparatus using the communication link established in the link establishment step; and
a restriction step of, when a predetermined number of communication sessions have been established, restricting establishment of communication sessions other than the established communication sessions.

11. A control method for a communication apparatus, comprising:
an opening step of opening a communication port when a communication link has been established with another communication apparatus in response to a request issued to establish the communication link;
a session establishment step of establishing a communication session with said another communication apparatus using the communication link established with said another communication apparatus;
a determination step of determining whether or not the communication session has been established with said another communication apparatus before the elapse of a predetermined time period since the establishment of the communication link;
a request step of, when the predetermined time period has elapsed without the communication session being established, re-requesting said another communication apparatus to establish a communication link; and
a closing step of closing the communication port when rejection of link establishment has been notified by said another communication apparatus in response to the re-request.

12. A communication apparatus comprising:
a link establishment unit configured to establish a communication link with another communication apparatus;
a session establishment unit configured to establish a communication session with said another communication apparatus using the communication link established by the link establishment unit; and
a rejection unit configured to reject requests for link establishment received after the session establishment unit has established a predetermined number of sessions.

13. The apparatus according to claim 12, further comprising
a releasing unit configured to, when a plurality of links have been established, execute processing for releasing sessions other than the predetermined number of sessions after the predetermined number of sessions have been established.

14. The apparatus according to claim 12, further comprising
a releasing unit configured to, when a plurality of links have been established, execute releasing processing with respect to requests for session establishment received after the predetermined number of sessions have been established.

15. A control method for a communication apparatus, wherein
when a predetermined number of communication sessions have been established with another communication apparatus using a communication link established with said another communication apparatus, requests for link establishment received thereafter are rejected.

16. A non-transitory computer readable storage medium storing a program for causing a computer to execute the steps of the control method for the communication apparatus according to claim 10.
